(19) United States
(12) Patent Application Publication
(10) Pub. No.: US 2008/0281922 A1
(43) Pub. Date: Nov. 13, 2008

(54) AUTOMATIC GENERATION OF EMAIL PREVIEWS AND SUMMARIES

(75) Inventors: Erin L. Renshaw, Kirkland, WA (US); John C. Platt, Bellevue, WA (US); Rajatish Mukherjee, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/746,149

(22) Filed: May 9, 2007

(51) Int. Cl. G06F 15/16

(52) U.S. Cl. 709/206

(57) ABSTRACT

An incoming electronic communication is broken down into message portions. Features of the message portions are extracted and the message portions are converted into sparse feature vectors. The probabilities of the message portions being of interest of the user are calculated and the message portions are converted back into text. Message portions with a relatively high probability of being of interest to a user are presented to the user as a summary.

### TECHNICAL FIELD

The subject specification relates generally to electronic text communication and in particular to generation of electronic mail summaries based on probability of interest to a user.

### BACKGROUND

Recent developments in communication technology allow for instant interaction between people through static communications. Many individuals send and receive numerous e-mails, text messages and the like throughout a day; technological developments allow people to monitor their incoming e-mails and similar communications constantly. The advent of cellular telephones, personal digital assistants, and the like allow individuals to check their e-mail without being in front of a desktop computer. This mobility allows for instant access to communication.

These developments have also placed a burden on the individuals that use instant communications. People receive such a large number of electronic communications that it can be difficult to perform other tasks without becoming constantly distracted by incoming messages. This can lower their productivity at work and damage personal relationships at home. Furthermore, messages can be long and detailed while only providing a few pieces of relevant information. Many messages begin with irrelevant introductory language that is passed through before a reader can ascertain the heart of a message. The amount of time it takes to discover a core message in a communication can also add to lost time that could be spent in endeavors that are more productive.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

To allow people to manage received electronic communications, summaries can be generated on content of a received message. This can allow a person to ascertain quickly core information of the message. However, a summary is only as effective as its content. The subject specification discloses information on generation of electronic communication summaries based on probability of a message portion being of interest to a user. An incoming message is broken down into message portions. Individual message portions are converted into vectors and the probability of the vectors being of interest to a user is calculated. Vectors are converted back to message portions and message portions with a high probability of being of interest to a user are displayed as a summary.

A summary of an electronic communication can be created thorough generation of a message preview. The message preview takes message portions with a high likelihood of interestingness and presents the message portions in a logical order. For example, the message portions can be presented an order that they appear in an original message. In another example, message portions in order of their probability of being of interest to a user, with the highest being displayed first.

A summary can also be created by implementing thread compression. Many e-mail messages are threads where there is not only a primary message (e.g., a message composed by a sender), but secondary messages that related to the primary message. A summary can be arranged that allows a reader to know both what is in a primary message and to know interesting information in a secondary message. This can be useful when a primary message is an answer to a question contained in a secondary message; the summary shows both the question and the answer.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a representative communication system that produces an electronic communication summary in accordance with an aspect of the subject specification.

FIG. 2 illustrates a representative communication system that produces an electronic communication summary with a stoppage component in accordance with an aspect of the subject specification.

FIG. 3 illustrates a representative communication system that produces an electronic communication summary with a language identification component in accordance with an aspect of the subject specification.

FIG. 4 illustrates a representative communication system that produces an electronic communication summary with a transmission component in accordance with an aspect of the subject specification.

FIG. 5 illustrates a representative operation of a preview component in accordance with an aspect of the subject specification.

FIG. 6 illustrates a representative operation of a thread compression component in accordance with an aspect of the subject specification.

FIG. 7a illustrates a first part of a representative methodology of electronic communication summary generation in accordance with an aspect of the subject specification.

FIG. 7b illustrates a second part of a representative methodology of electronic communication summary generation in accordance with an aspect of the subject specification.

FIG. 8 illustrates a representative methodology of classifier training in accordance with an aspect of the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

When receiving an electronic communication (e.g., e-mail, text message, instant message, etc.), a summary can be generated that shows some of the information that is present in the communication. However, the summary may not show information that is of interest to a user. In order to generate a summary with important information, the electronic communication is broken down into fragments the probability that a fragment will be of interest to a user is calculated. Fragments with a high probability of being of interest should be used to create a summary.

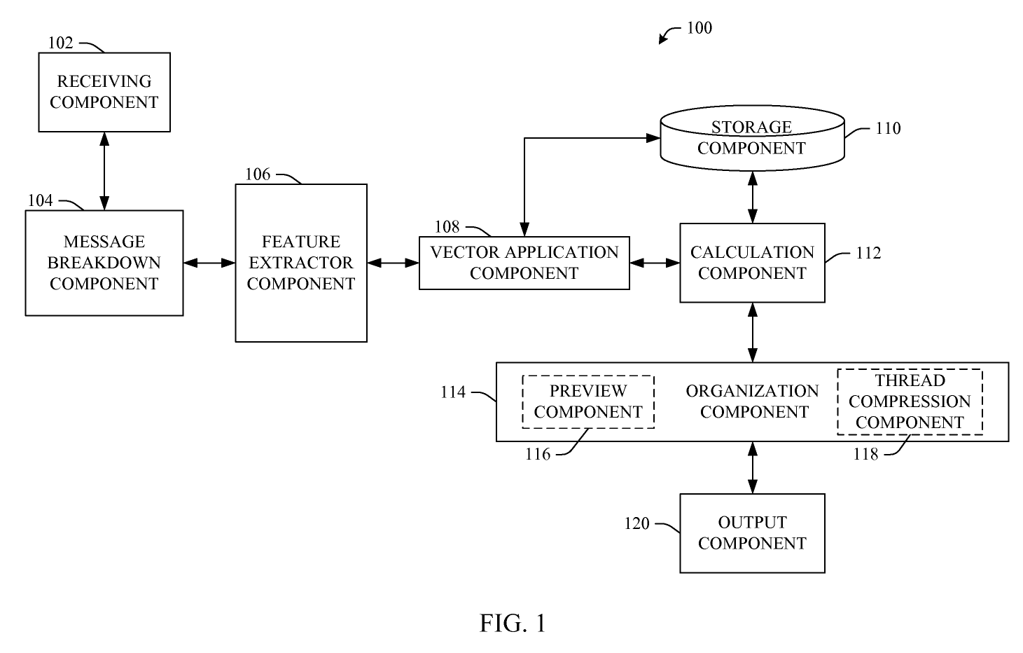

FIG. 1 discloses an example communication system 100 implementing at least some aspects of the subject specification. The system 100 can be implemented on a number of different devices; for example, a personal computer, a personal digital assistant, a cellular telephone, etc. A receiving component 102 obtains a message that will ultimately be processed by other components. The receiving component 102 can operate according to a number of different configurations. For example, the receiving component 102 communicates with a central database for obtaining message (e.g., the receiving component 102 is on a network and is capable of communication with a server). Communication with the receiving component 102 can take place in a number of different embodiments, which include wireless communication, hardwire communication, etc.

The receiving component 102 can obtain the message in a number of different manners. According to one embodiment, the receiving component 102 passively accepts incoming messages. For example, a message can enter a device that holds the receiving component 102 and the message can be directed to the receiving component 102 by a processor. According to another embodiment, the receiving component 102 actively attempts to obtain messages. For example, after a specific increment of time (e.g., five seconds), the receiving component 102 checks if there are any messages related to the system 100. If there are related messages, then the receiving component 102 obtains them and transfers a message to a message breakdown component 104.

The message breakdown component 104 takes a received message and deconstructs the message, if applicable. For example, the message breakdown component 104 looks to break a six-sentence message down into six different parts. The purpose of breaking down a message is to analyze the message parts to determine which parts are likely to be of interest to a user. The message breakdown component 104 can break down message parts such as header information (e.g., from, to, cc, subject, etc.), greetings, signatures, etc.

However, it is possible that a received message is communicated in a less formal setting. For example, individuals using e-mail communication can be less likely to use formal language when sending messages. Informal language communication can include sending sentence fragments that are not true sentences and/or statements that lack proper punctuation to classify as sentences. Alternatively, if the system 100 is applied to voice mail messages, then the words of the voice mail are extracted by receiving component 102 wherein commonly no punctuation or capitalization can be derived. The message breakdown component 104 can configure to deconstruct a message in a manner other then formal sentence breakdown. For example, the message breakdown component 104 can attempt to identify fragments that have a capital letter in a non-proper noun and them as break points. This can signify there a full message portion and it could be worthwhile analyzing further. On the other hand, the message breakdown component 104 can create fragments from a sliding window of a fixed number of words (e.g., 10), where the sliding window generates a fragment words in the communication.

A broken down message travels to a feature extractor component 106 where message portions are analyzed. Analysis is typically looking at one, two, or three word sets of the message portions; these sets can be defined as unigrams, bigrams, and trigrams respectively. For example, one message portion can be ‘What time is the meeting?’ The feature extractor component 106 looks at the following segments: ‘What’, ‘time’, ‘is’, ‘the’, ‘meeting?’, ‘What time’, ‘time is’, ‘is the’, ‘the meeting?’, ‘What time is’, ‘time is the’, and ‘is the meeting?’. However, the feature extractor component 106 can operate in different manners; for example, the feature extractor component 106 can identify a non-consecutive combination (e.g., ‘What is meeting?’).

A vector application component 108 takes a message portion and converts the message portion into a long vector. According to one embodiment, each message portion is represented as a long vector of zeros. The length of the vector is the number of possible interesting features. The vector that specifies the classifier, and its mapping of feature definitions to locations within the vector are saved in a storage component 110.

For example, there can be 20,000 features that are defined as interesting in the classifier. The initial representation of a message portion will have 20,000 zeros. If a message portion feature is present in the message portion, then the value in the vector can change from a zero to a non-zero, such as a one (e.g., the term ‘what time is’ is located in the message portion, so the corresponding value of the message portion vector changes from a zero to a one). This converts a message portion into a feature vector.

A calculation component 112 determines the probability that the message portion (represented by its feature vector) is of interest of to a user. The calculation component 112 determines or infers respective probabilities associated with message portions being of interest to a user. According to one embodiment, logistic regression is used to determine a probability. For example, the vector can be represented as ‘x’. A dot product of the vector ‘x’ against a weight vector ‘w’ is equal to:

$${\sum }_{i} {w}_{i} {x}_{i} + k ,$$

where ‘i’ is equal to the number of features and k is an offset constant. The determination of the weight vector ‘w’ and the offset constant ‘k’ given a training set of labeled examples can be performed through conventional manners. A weight vector can be used to determine how much a specific feature contributes to the interestingness of a message portion to a user. The dot product is placed into the following equation.

$$\frac{1}{1 + {x}^{- ( {\sum }_{i} {w}_{i} {x}_{i} + k )}}$$

The result of the equation is the probability that the message portion will be of interest to a user. It is to be appreciated that while logistic regression and specific equations are disclosed; there can be other implementations of the calculation component 112. The calculation component 112 contains at least one classifier.

According to one embodiment, there are multiple classifiers that share the same feature vector. However, the classifiers compute different functions. For example, there can be two classifiers; one classifier determines sentence interestingness and another classifier determines whether a sentence is uninteresting.

In general, there is creation of rules that consider outputs of one or more classifiers. When multiple classifiers are involved, the outputs are ranked. According to one embodiment, the output of ‘classifier B’ is considered first. If there are three sentences identified as important by ‘classifier B’, then the three sentences are used in a summary. If there are fewer then three sentences identified as important by ‘classifier B’, then ‘classifier A’ detects important sentences. In this embodiment, presentation can be of the summary is in order that sentences appear in an original message.

Once interestingness is determined, fragments travel to an organization component 114, where summaries of interesting message portions are prepared. The organization component 114 operates to allow message portions to be configured in an arrangement that is likely to be of use to a user. The organization component 114 selects, as a function of the determined or inferred probabilities, at least one of the message portions for presentation to the user. The organization component 114 can convert a message portion vector into a message portion.

Two common components operate to create a beneficial arrangement: a preview component 116 and a thread compression component 118. The organization component 114 can contain logic that selects if a preview component 116 should be used and/or a thread compression component 118 should be used. Furthermore, the logic can select to user a different organizational type then the ones disclosed (e.g., displaying interesting proper names).

The preview component 116 arranges interesting message portions based on a logical flow. For example, the preview component can arrange message portions in an order in relation with how they are arranged in the message. Message portions with a high probability of being interesting to a user can be arranged in order of how portions appear in an original message. According to another embodiment, the message portions are arranged in an order that allows the most interesting message portions to be displayed first.

For example, the preview component can operate with utilization of at least two classifiers. ‘Classifier B’ attempts to find three interesting sentences. If ‘Classifier B’ cannot find three interesting sentences, ‘classifier A’ is used to find interesting sentences. Commonly, ‘classifier A’ is less specific then ‘classifier B.’ In this example, up to three sentences are selected and presented with sender identification information.

The thread compression component 118 attempts to arrange message portions from different parts of a thread (e.g., a principle message and trail messages). The arrangement attempts to simulate a conversation to allow a user to ascertain quickly the core of the message. For example, a user could have sent a question to a friend asking the final score of a baseball game (e.g., what was the final score of the Mariners-Rangers game?). The friend could send an incoming message with the score (e.g., 8-6). However, if it has been some time since the message was sent, a mere preview of ‘8-6’ could be confusing to the user. Therefore, the thread compression component 118 allows for the presentment of both a question and an answer (e.g., what was the final score of the Mariners-Rangers game? 8-6).

For example, the thread compression component can operate with utilization of at least two classifiers. A specified number of sub-threads can be checked (e.g., up to five sub-threads.) ‘Classifier B’ attempts to find four interesting sentences. If ‘Classifier B’ cannot find four interesting sentences, ‘classifier A’ is used to find interesting sentences. While the number of sentences (e.g., three, four, etc.) to be used in a generated summary (e.g., preview, thread compression, etc.) is to be less then the number of sentences in message, the number should be set at a level that is not overwhelming to a typical user. For example, a 20-sentence message can be summarized by 19 sentences, but it is likely more beneficial to summarized in three to five sentences.

An output component 120 presents a summary of interesting message portions arranged by the organization component 114. According to one embodiment, the output component 120 is a graphical form that allows for visual presentment of a summary. For example, a small box containing the summary can be presented in a corner of a display of the output component 120. According to another embodiment, the output component 120 has an audio presentment of the summary (e.g., a set of speakers that produce a digital voice reading the summary).

In a further embodiment, a message can be obtained by the receiving component 102 that is incapable of being fragmented (e.g., a very short message). The message can bypass the message breakdown component 104 (e.g., the message is made up of one fragment), and the organization component selects the fragment for presentation since it is the sole available fragment.

However, the organization component can then determine if the selected fragment should be presented. For example, a calculation can take place to determine whether the probability is above a certain threshold. If the probability is above the threshold, then the selected fragment is processed into a summary and presented to the user. If the probability is not above the threshold, then no summary is presented.

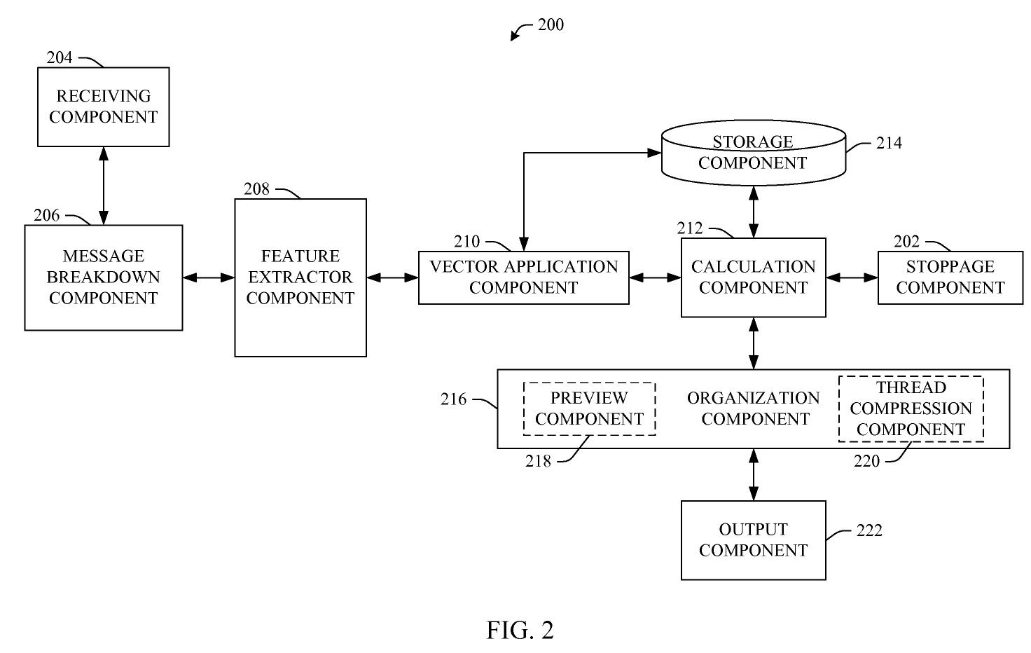

FIG. 2 discloses a system 200 for generating message summaries with a stoppage component 202. A receiving component 204 inputs and does preliminary processing of a message (e.g., identifies the message type). A message breakdown component 206 divides a received message into portions; divisions typically taking place at sentence breaks. A feature extractor component 208 defines feature in the message portions. A vector application component 210 changes features into vectors so the features can be analyzed by a calculation component 212.

The calculation component 212 determines a probability that a message portion will be of interest to a user. The probability of interest of features determines the probability that a message portion is of interest to a user (e.g., the more interesting features in a sentence, the more interesting the sentence will be). Calculation of interestingness is based on a classifier located in a storage component 214. A summary of message portions with a high likelihood of interestingness is created by an organization component 216. The organization component can include a preview component 218 and/or a thread compression component 220. Ultimately, a generated summary transfers out through an output component 222.

A stoppage component 202 assists in regulating the operation of the calculation component 212 and/or the system 200. The system 200 can function in multiple manners. According to one embodiment, the stoppage component 202 observes the likelihood of the interestingness of the message portions. The stoppage component 202 can contain a threshold value (e.g., 70% chance of a message portion being of interest to a user) or read a threshold value from a storage component 214. After a set number of message portions have been analyzed to have at least the threshold value, then the stoppage component 202 stops calculations and has the organization component 216 create a summary.

This would be beneficial when the space to display a summary is small and/or the received message is very long. This saves time and resources by not requiring a full analysis of all message portions. Furthermore, in a system 200 where components operate concurrently, if a threshold is achieved, then the stoppage component 202 can stop other components from operating. For example, this can save resources in systems 200 where the feature extractor component 208, message breakdown component 206, and/or vector application component 210 take a long time to operate and require a large amount of system resources (e.g., components stop functioning prior to complete analysis of a message).

In another embodiment, the system 200 calculates the probability of interestingness for each message portion prior to creation of a summary. The message portions with the highest probability of interestingness to a user transfer to the organization component 216 to create a summary. The stoppage component 202 prevents relatively low probability message portions from transferring to the organization component 216. In a further embodiment, the organization component 216 can receive all message portions and select which portions to use in a summary. The stoppage component 216 can stop functioning if a set number of message portions are designated as having near 100% probability of interestingness to a user.

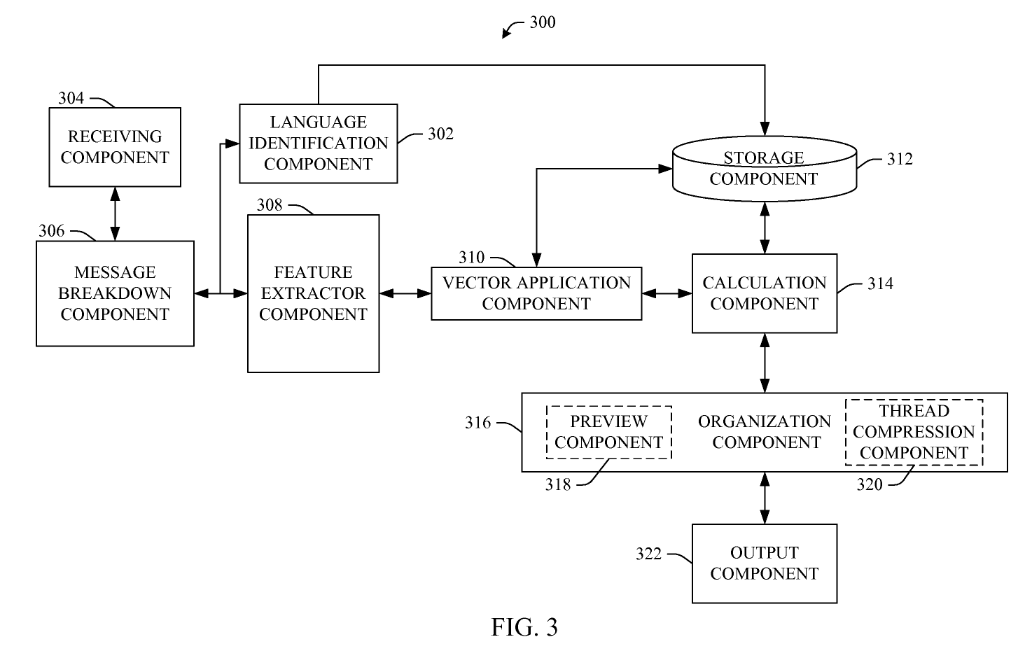

FIG. 3 discloses an example electronic communication summary generation system 300 with a language identification component 302. A receiving component 304 obtains an electronic communication. The electronic communication transfers to a message breakdown component 306. The message breakdown component 306 divides the electronic communication into smaller portions, if applicable.

While the language identification component is shown functioning between the message breakdown component 306 and a feature extractor component 308, there can be other configurations. For example, the language identification component 302 can operate prior to a message being obtained by the receiving component 304. If the system 300 cannot handle a different language, then the message can travel to a processor for full presentment (e.g., a received message is in English, but the system is only capable of handling messages in Spanish).

In another example, the language identification component 302 can function between the receiving component 304 and the message breakdown component 306. The language identification component 302 can assist in determining where an electronic communication should be broken. Different languages can have different punctuation that should be taken into account when breaking down a message.

A feature extractor component 308 determines what features are present in the smaller portions of the electronic communication. Base on the present features, smaller portions are converted into sparse feature vectors by a vector application component 310. This is done through use of a classifier present in a storage component 312.

The language identification component 302 can determine what a language of a received message. This can be important for a number of different reasons relating to the system 300. For example, if a user receives electronic communication in multiple languages, then the language identification component 302 can identify which communication is in what language and how it should be further analyzed. The language identification component 302 thus communicates with storage component 312, to select parameters for calculation component 314 that are appropriate for the incoming language

According to one embodiment, different features are used for different languages. In addition, different weight vectors are used for different languages. The language identification component 302 communicates with a storage component 312 to identify which classifier to use for text in a language. The vector application component 310 can obtain this information from the language identification component 302. This can be beneficial because without this characteristic, there would be undesirable errors. Using the above example, English features would commonly not occur in a French message.

The probability of the small portion being of interest to a user is determined through a calculation component 314. Vectors with a relatively high probability of being of interest to a user are converted to text and arranged into a summary by an organization component 316. The organization component 316 can utilize a preview component 318 and/or a thread compression component 320. The summary is displayed through an output component 322.

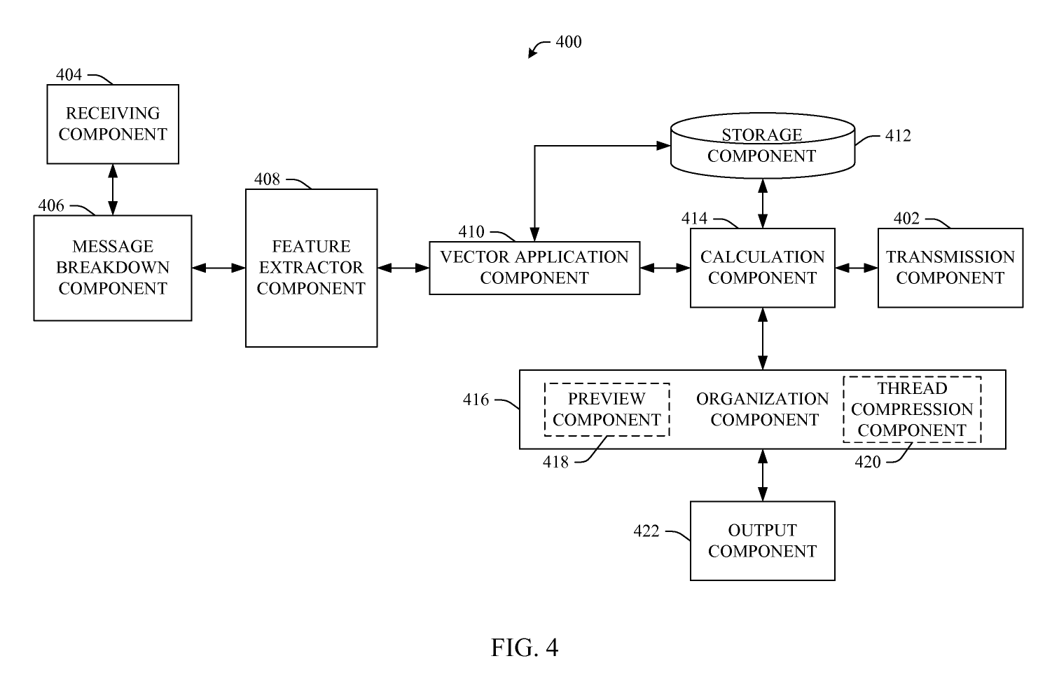

FIG. 4 discloses an example summary generation system 400 with a transmission component 402. A receiving component 404 gathers a message from an auxiliary source. The message is broken down into smaller fragments if possible by a message breakdown component 406. A feature extractor component 408 determines different features located within a message fragment. A vector application component 410 converts the message fragment into a feature vector based on a classifier (e.g., linear classifier) located in a storage component 412.

A calculation component 414 determines the probability that the feature vector that represents a message fragment is of interest to a user. An organization component 416 can arrange a summary for presentment to a user based on message fragments with a high probability for being interesting. The organization component 416 can convert feature vectors back to message fragments. Furthermore, the organization component 416 can utilize a preview component 418 and/or a thread compression component 420 to create a summary. An output component 422 displays a created summary to a user.

The transmission component 402 can send data that concerns probability that a message portion is interesting to an auxiliary device. This means that any information relating to the operation of the system 400 can be sent to an auxiliary device since the system operates to determine probability that a message portion is interesting. For example, information as to what features are found most often in incoming messages can be transmitted to a central database. The central database can transmit information back to the system through the transmission component 402 on how to modify the calculation component 414 accordingly (e.g., change the weight value of a specific feature).

According to another embodiment, the transmission component 402 sends information relating to diagnostics of the system 400. For example, the transmission component 402 can test various components and send a message to a server as to the operation of the components. The server can send back information on how to correct discovered errors. In a further embodiment, the transmission component 402 can send information to an auxiliary storage unit about operation of the system 400. For example, the auxiliary storage unit can hold the information for evaluation purposes.

According to a further embodiment, the output component 422 is a portable device (e.g., a personal digital assistant). However, there could be no physical connection between the output component 422 and other components disclosed in the system 400 (e.g., the organization component 416). Therefore, the transmission component 402 can communicate a summary to the output component 422. If a user of the output component 422 would like to see a whole message, the output component 422 can send a message to the transmission component 402 requesting the whole message. The transmission component 402 can receive and process the request and transfer the whole message to the output component 422.

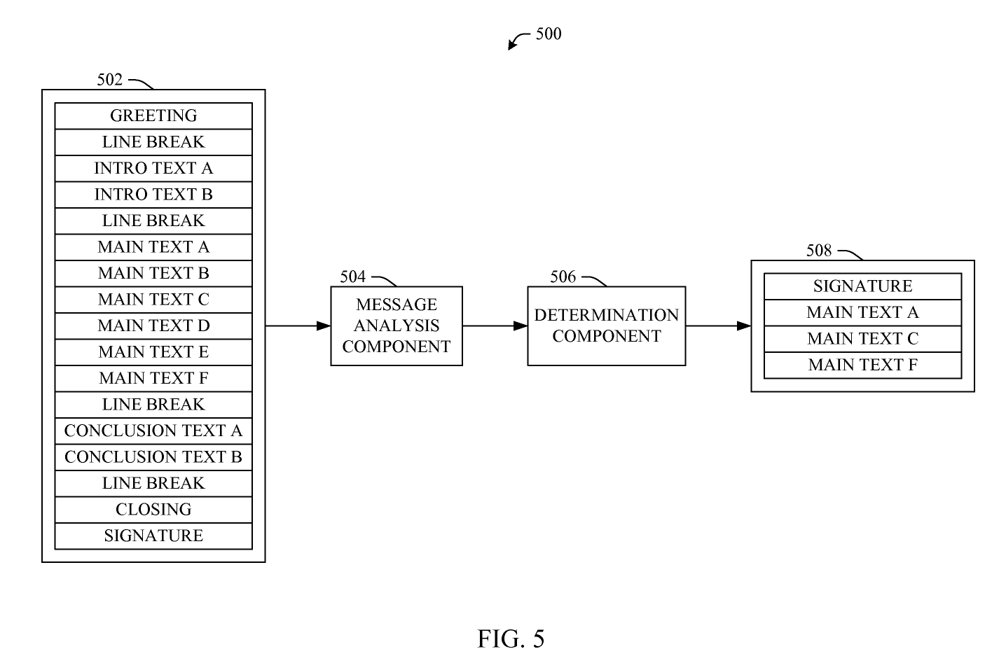

FIG. 5 discloses an example operation 500 of a preview component. The disclosed example is for explanation only and not intended to show results of an experiment or the like. For example, a message 502 enters into a message analysis component 504. The message analysis component 504 performs various functions of previously disclosed components. For example, the message analysis component 504 can break down a message and extract features from the message.

A determination component 506 compiles a summary 508 for display to a user. For example, the determination component 506 can calculate probability of message portions being of interest to a user and organize the message portions into a summary 508. The message analysis component 504 and determination component 506 can combine to form a system similar to other systems disclosed in other areas of the subject specification (e.g., system 100 of FIG. 1, etc.). The following is an example message 502 where text between [ ] signifies a break of a message portion that equates with what is disclosed in FIG. 5.

Hi John: [GREETING]

[LINE BREAK]

We have not gone out in a long time. [INTRO TEXT A] We will have to get together in the near future. [INTRO TEXT B]

[LINE BREAK]

Do you think you would like to go to The Lion King at the State Theatre this weekend? [MAIN TEXT A] It is the play based off that Disney movie. [MAIN TEXT B] I have an extra VIP ticket for $130 if you are interested. [MAIN TEXT C] The play is directed by Julie Taymor. [MAIN TEXT D] Did you know that she was in one of my play classes at Oberlin College (I love saying ‘play’ over ‘theatre’:) [MAIN TEXT E] Let me know by Thursday if you are interested in going. [MAIN TEXT F]

[LINE BREAK]

If you cannot go, we will have to get lunch sometime. [CONCLUSION TEXT A] Just remember, I paid last time so next time is on you. [CONCLUSION TEXT B]

Take care, [CLOSING]

Larry [SIGNATURE]

Through operation of the message analysis component 504 and the determination component 506, the probability of interestingness of each identified message portion can be calculated. For example, a classifier that is part of the determination component 506 can be used to identify that sentences that include a a ‘$’, or contain the phrase ‘let me know’ as features possess a high likelihood of probability of being interesting to a user. Furthermore, the message analysis component 504 can include a capability to identify a signature. This can be through analysis of the message 502 or through analysis of header information (e.g., information listed in ‘From’ line.) The signature is then included in the summary. This can take place outside of interestingness detection and the signature is copied into a summary. A summary can be generated such as the following:

From Larry:

Do you think you would like to go to The Lion King at the State Theatre this weekend? I have an extra VIP ticket for $130 if you are interested. Let me know by Thursday if you are interested in going.

As can be seen, an analysis of probability of interestingness can provide a summary 508 with important information. The question, price, and timeframe are provided to a user. Summary generation systems that rely on principles other then interestingness could lead to less informative summaries.

For example, a summary generation based on the first three physical lines can generate:

From Larry:

We have not gone out in a long time. We will have to get together in the near future.

As can be seen, the true core of the message 502 (e.g., the questions concerning the play) is missed in this summary and a user would have to read the full message 502 to appreciate the core of the message 502. In another example, a summary generation based on a keyword search (e.g., the word play is present four times) can generate:

From Larry:

It is the play based off that Disney movie. The play is directed by Julie Taymor. Did you know that she was in one of my play classes at Oberlin College (I love saying ‘play’ over ‘theatre’:)

This summary also misses the true core of the message 502. While information is shown relating the play, a reader of the summary has no idea that they are being invited to a play or even what play is in discussion (since the term ‘it’ is used). As can be seen, a summary 508 based on a probability of interestingness to a user can provide useful information.

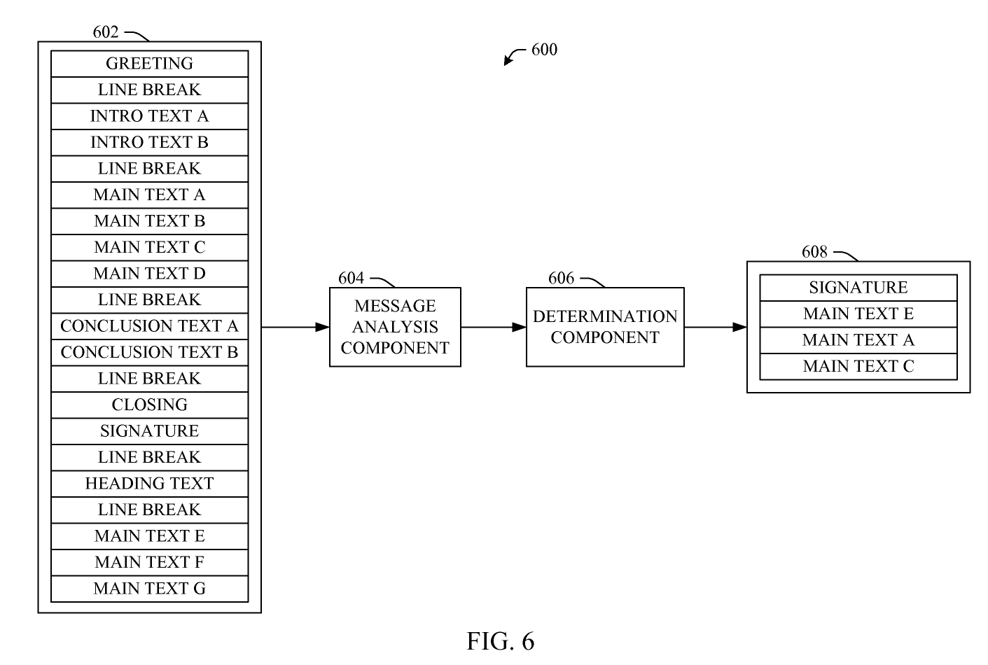

FIG. 6 discloses an example operation 600 of a thread compression component. The disclosed example is for explanation only and not intended to show results of an experiment or the like. For example, a message 602 is gathered by a received of a message analysis component 604. The message contains both a current message and a previous message (e.g., a message thread). The message analysis component 604 performs functions previously disclosed in the subject specification. For example, the message analysis component 604 can break down a message and extract features from the message.

A determination component 606 generates a summary 608 that is ultimately presented to a user. For example, the determination component 606 can calculate probability of message portions being of interest to a user and organize the message portions into a summary 608. The message analysis component 604 and determination component 606 can combine to form a system similar to other systems disclosed in other areas of the subject specification (e.g., system 100 of FIG. 1, etc.). The following is an example message 602 where text between [ ] signifies a break of a message portion that equates with what is disclosed in FIG. 6.

Hi Terry: [GREETING]

[LINE BREAK]

50. [INTRO TEXT A] That's my opinion. [INTRO TEXT B]

[LINE BREAK]

I think that 50 2×4s would be enough to complete the project. [MAIN TEXT A] I don't want to get too many and be stuck with leftovers that cannot be placed in the deck. [MAIN TEXT B] If we are short, then we can always get more with little to no harm. [MAIN TEXT C] Worst case scenario, we stain all the whole deck so it all looks the same and no one will know they are from two shipments. [MAIN TEXT D]

[LINE BREAK]

I really think this deck project will be a nice addition to your home. [CONCLUSION TEXT A] Thank you for using me as your contractor. [CONCLUSION TEXT B]

[LINE BREAK]

Regards, [CLOSING]

John [SIGNATURE]

[LINE BREAK]

From: Terry, To: John, Dated Apr. 06, 2006 [HEADING TEXT]

[LINE BREAK]

How many 2×4s do you think we will need to order? [MAIN TEXT E] I am really looking forward to this deck. [MAIN TEXT F] I was thrilled to hear it should be done before my kids are done with school. [MAIN TEXT G]

The probability of interestingness of each identified message portion can be calculated. For example, a classifier that is part of the determination component 606 can be used to identify that sentences that include a ‘?’, a number with words, or contain the phrase ‘I think’ as features possess a high likelihood of probability of being interesting to a user. It is to be appreciated that the operation can handle informal language (e.g., ‘don't’ as opposed to ‘do not’). It should be noted that a summary 608 (or a summary 608 of FIG. 6) can have message portions arranged in a different order in the summary 608 then in the message 602. A summary can be generated such as the following:

From Terry:

How many 2×4s do you think we will need to order?

From John:

I think that 50 2×4s would be enough to complete the project. If we are short, then we can always get more with little to no harm.

The summary 608 shows both the answer and the questions. This can allow a user to understand quickly provided information. Identifiers can be inserted, such as showing which part of a thread a message portion originates (e.g., How many 2×4s do you think we will need to order? (Terry to John)). Summary generation systems that rely on principles other then interestingness could lead to less informative summaries.

For example, a summary generation based on the first three text portions can generate:

From John:

50. That's my opinion.

If the user is not immediately familiar with the message, a mere number would not provide sufficient information. Furthermore, while a message 602 with two notes is disclosed, thread compression can take place concerning much longer messages. For example, a message 602 can include twelve e-mails. It can take a user a long time to look through e-mails in the thread to determine what the meaning of ‘50’. Furthermore, if there are multiple questions, this can be even more confusing to a user. The subject specification can attempt to elevate the confusion by using thread compression (e.g., a weight vector can be used to assist in determining what question is related to the response ‘50’).

Furthermore, use of a keyword search could provide the following summary (e.g., the word ‘deck’ is defined as a keyword):

From John:

I don't want to get too many and be stuck with leftovers that cannot be placed in the deck. Worst case scenario, we stain all the whole deck so it all looks the same and no one will know they are from two shipments. I really think this deck project will be a nice addition to your home. I am really looking forward to this deck.

The summary generated from a keyword does not show the question or the answer. Without a calculation of a probability of interestingness to a user, the core of the message can be lost. It is to be appreciated that the preview component operation and thread compressor operation can configure into an operation component (e.g., the operation component 114 of FIG. 1, etc.). Therefore, features that are disclosed for the preview component can also be used by the thread compressor and vise versa (e.g., the addition of identifiers).

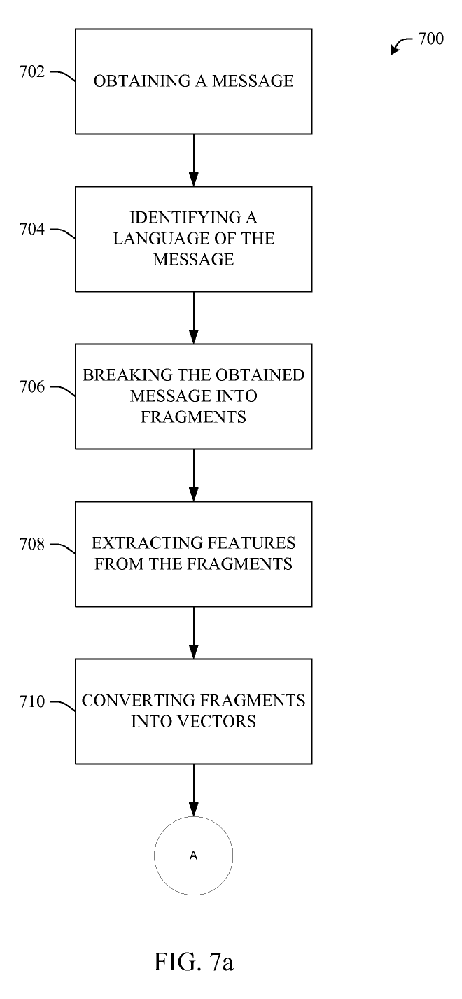

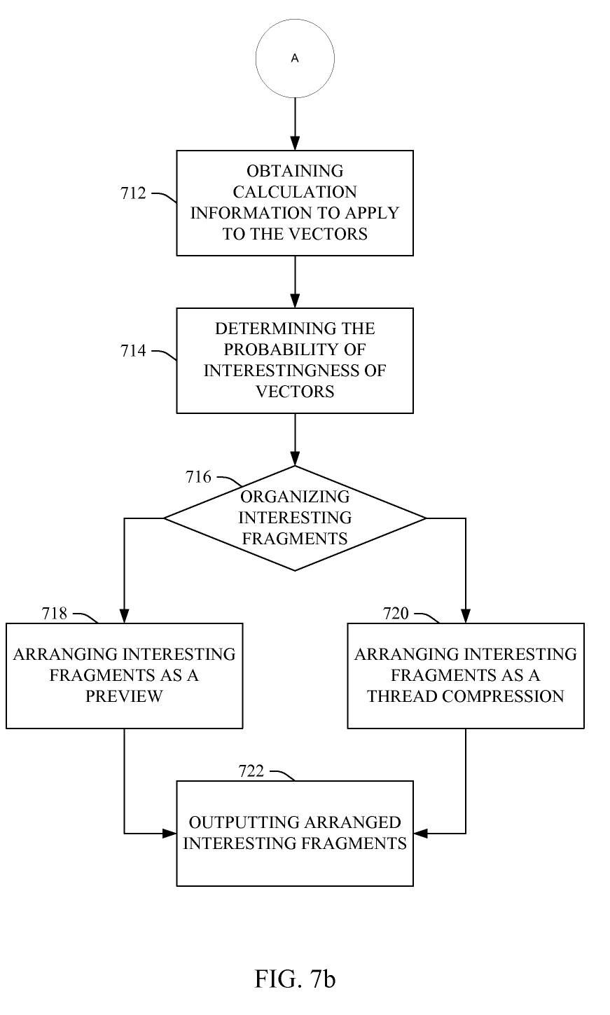

FIG. 7a and FIG. 7b discloses a methodology 700 for generating a summary for an electronic message. A summarizable message is obtained at 702. Once the message is obtained, a language of the message is determined 704. Different classifiers can be used by the methodology based on a language of an obtained message.

The obtained message is broken down into fragments 706. Breaking a message into fragments allows the fragments to be individually analyzed to determine the probability of being of interest to a user. Once the message is broken down, features of the fragments are extracted 708. Features can be one, two, or three word combinations. However, features can also be other items, such as punctuation. Based on features, the message portions are converted into feature vectors.

At least one message fragment is converted into a vector 710. For example, a message portions converts to a vector of values where each value represent one possible feature in a classifier If a feature appears in the message portion, and is usable by the classifier, it obtains a non-zero value. While the vector value can be either zero or one, it is possible that the value can contain another type, such as a floating-point value.

Once a feature vector is created, calculation information is obtained 712 where the calculation information is ultimately applied to the feature vector. The calculation information can be an equation that processes the feature vector. The calculation information is applied to the feature vector to determine the probability that a message fragment represented by the feature vector is of interest to a user 714. This is determining probability of interestingness of the vector to a user. This can take place for each for each the vectors, or only enough vector that it takes to create an efficient summary.

Vector with a high probability of being of interest of a user causes its associated text fragment to be appropriately organized 716. This can take place for multiple vectors. The interesting message fragments can be arranged into a summary in multiple manners. In one embodiment, message fragments with a high value of interestingness to a user are arranged as a preview (e.g., an organized compilation of fragments). In another embodiment, message fragments that have a high likelihood of being interesting to a user can be arranged as a thread compression. This can be done in a similar manner to operation of the preview component 116 of FIG. 1 and/or the thread compression component 118 of FIG. 1. Message fragments organized into a summary are outputted and presented to a user.

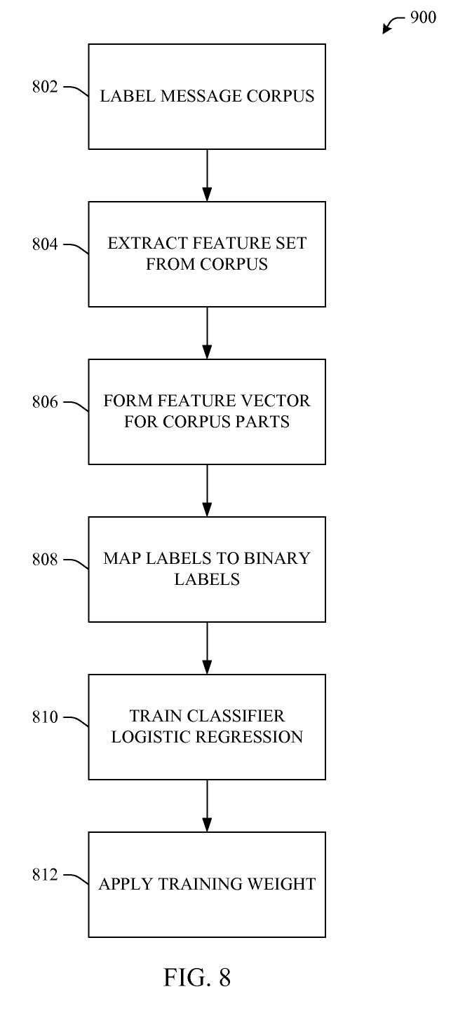

FIG. 8 discloses a methodology 800 for training a classifier that is used concerning various aspects disclosed in the subject specification. An initial corpus is labeled into distinct smaller portions 802. For example, a received corpus has each sentence-like structure labeled and broken down to corpus fragments. Features are extracted from the corpus 804; for example, where a feature is a word combination of one, two, or three words. The classifier can utilize features that occur more often or less often than a fixed number of times in the corpus. For example, the classifier can use features that occur in less than seven percent of the emails in the corpus, and more than one email in 1000. Each corpus fragment has a feature vector that relates to the corpus fragment 806. This can be a binary representation of a presence or absence of a feature. Labels are then mapped to binary labels 808 (e.g., message fragments are given number portions). Once complete, the classifier is trained 810 and a training weight is applied 812. Training can take place through numerous different embodiments utilizing a plurality of different methods. According to one embodiment, the classifier is trained through logistic regression. In another embodiment, the classifier is trained through a support vector machine.

The methodology 800 assists in demonstrating use of multiple classifiers. For example, two classifiers can be trained; a first classifier to detect known interesting sentences (classifier A) and a second classifier to detect known uninteresting sentences (classifier B). Message fragments are labeled with a sentence type. For example, possible sentence types can be known interesting sentences (e.g., requesting a task, making a promise, suggesting a meeting, etc.), known uninteresting sentences (e.g., signatures, chitchat, greetings, mail headers, etc.), and unknown sentences. The first classifier is trained with known interesting sentences as positive targets and the rest as negative targets. The second classifier is trained with known interesting stances and unknown sentences as positive targets and known uninteresting sentences as negative targets.

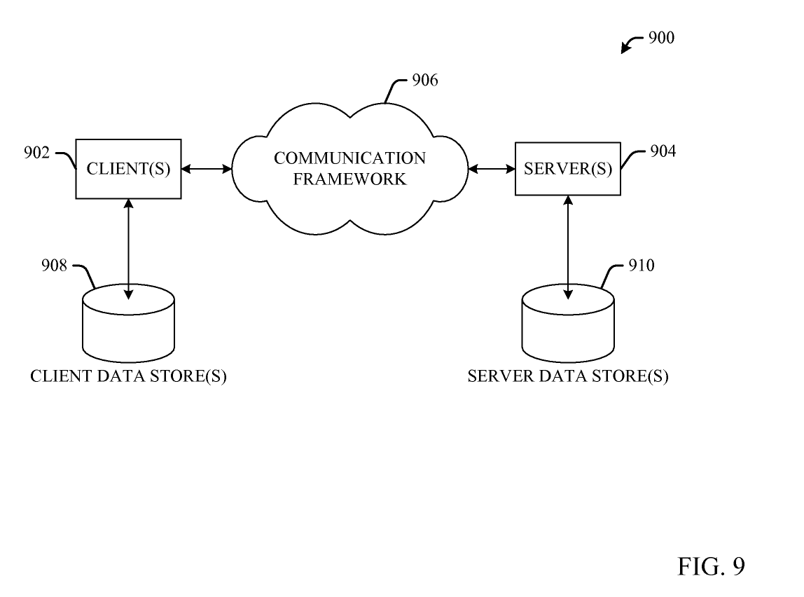

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

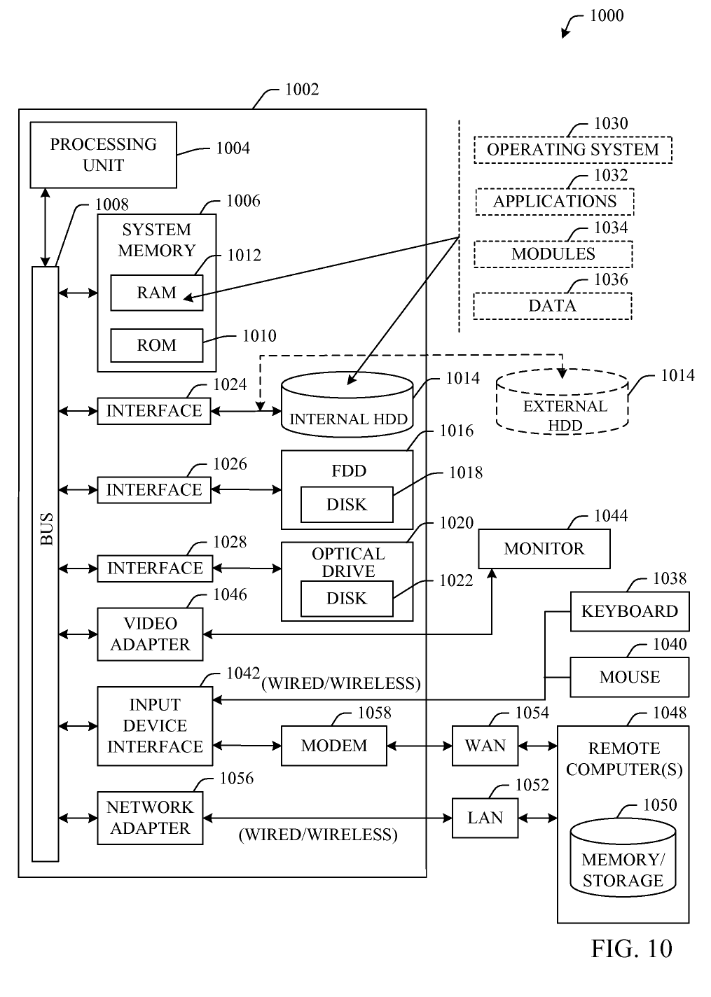

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a calculation component that determines or infers respective probabilities associated with message portions being of interest to a user; and
an organization component that selects, as a function of the determined or inferred probabilities, at least one of the message portions for presentation to the user.

2. The system of claim 1, further comprising a language identification component that determines language characteristics of a message portion.

3. The system of claim 1, further comprising a message breakdown component that divides a message into at least two portions.

4. The system of claim 1, wherein the organization component comprises a preview component that arranges at least one selected message portion for presentation to the user.

5. The system of claim 1, wherein the organization component selects a message portion with a highest probability of being interesting.

6. The system of claim 1, wherein the organization component selects a message portion that is above a pre-defined threshold.

7. The system of claim 1, wherein the organization component comprises a thread compressor component that presents a new message made of at least one selected message portions.

8. The system of claim 1, wherein the calculation component makes a determination or inference through utilization of at least one trained classifier.

9. The system of claim 1, further comprising a vector application component that converts a message portion into a vector.

10. The system of claim 1, wherein the calculation component employs, at least in part, the probability equation:
$$\frac{1}{1 + {x}^{- ( {\sum }_{i} {w}_{i} {x}_{i} + k )}}$$
where i is a number of features,
w is a weight vector,
x is a vector and,
k is an offset constant.

11. The system of claim 1, further comprising a stoppage component that can stop calculations of probability if a message portion threshold is reached.

12. The system of claim 1, further comprising a feature extractor component that searches for features in a message portion for use by the calculation component in determination of probability.

13. The system of claim 1, further comprising a transmission component that sends data that concerns probability that a message portion is interesting to an auxiliary device.

14. A method, comprising:
converting at least one message fragment into a vector; and
determining probability of interestingness of the vector to a user.

15. The method of claim 14, further comprising identifying a language of the message.

16. The method of claim 14, further comprising breaking a message into message fragments.

17. The method of claim 14, further comprising extracting features from at least one message fragment for use in determining the probability of interestingness of the vector.

18. The method of claim 14, further comprising arranging interesting fragments as a preview.

19. The method of claim 14, further comprising arranging interesting fragments as a thread compression.

20. A system for text message summarization, comprising:
means for creating a plurality of text fragments from text communication;
means for applying at least one classifier upon the text fragments to determine a probability of a text fragment being of interest to a user; and
means for using output from application of the classifier upon the text fragments to select summary text fragments.
